(19) United States
(12) Patent Application Publication
(10) Pub. No.: US 2020/0147891 A1
(43) Pub. Date: May 14, 2020

(54) THREE-DIMENSIONAL PRINTING APPARATUS

(71) Applicants: XYZprinting, Inc., New Taipei City (TW); Kinpo Electronics, Inc., New Taipei City (TW)

(72) Inventors: Shih-Wei Huang, New Taipei City (TW); Po-Hsuan Lai, New Taipei City (TW)

(73) Assignees: XYZprinting, Inc., New Taipei City (TW); Kinpo Electronics, Inc., New Taipei City (TW)

(21) Appl. No.: 16/245,237

(22) Filed: Jan. 10, 2019

(30) Foreign Application Priority Data
Nov. 12, 2018 (CN) 201811338062.8

(51) Int. Cl. B29C 64/393; B29C 64/118; B29C 64/245; B29C 64/25

(52) U.S. Cl. CPC B29C 64/393; B29C 64/118; B33Y 10/00; B29C 64/25; B29C 64/245

(57) ABSTRACT

A three-dimensional printing apparatus includes a platform, a printing head, a filament box, a connecting member and a guiding tube. The connecting member is disposed between the printing head and the filament box, and includes a main body, a first transfer tube, a second transfer tube and a third transfer tube. The first transfer tube, the second transfer tube and the third transfer tube are detachably mounted to the main body. The main body has a first passage, a second passage and a third passage that communicate with each other. The first transfer tube, the second transfer tube and the third transfer tube communicate respectively with the first passage, the second passage and the third passage. The guiding tube is connected to the third transfer tube and the printing head, and communicates with the third transfer tube.

### CROSS-REFERENCE TO RELATED APPLICATION

This application claims the priority benefit of Chinese application serial no. 201811338062.8, filed on Nov. 12, 2018. The entirety of the above-mentioned patent application is hereby incorporated by reference herein and made a part of this specification.

### BACKGROUND

### Technical Field

The disclosure relates to a printing apparatus, and in particular, to a three-dimensional printing apparatus.

### Description of Related Art

With the advancement of technology, the three-dimensional printing technique has become increasingly mature. Specifically, through the three-dimensional printing technique, a digital three-dimensional model can be quickly materialized by stacking, which not only simplifies the manufacturing process and improves the manufacturing efficiency, but also avoids waste of material and cost. Compared to the conventional subtractive processing, the three-dimensional printing technique is more competitive.

Taking the three-dimensional printing technique of fused deposition modeling (FDM) as an example, the manufacturing method comprising heating and melting a hot melt filament and let the melted filament be cured and shaped is adopted. In the process of three-dimensional printing, if the filament is exhausted, the manufacturing process is interrupted, and the operator is required to manually supplement the filament, which delays the manufacturing process. On the other hand, the multi-color printing technique has been proposed. In other words, in the process of three-dimensional printing, filaments of different colors may be alternated to perform the printing operation according to the color arrangement of different printing layers or blocks. However, the alternation of filaments of different colors is also manually performed by the operator, which similarly results in conditions such as a manufacturing process interruption and a manufacturing process delay.

### SUMMARY

The disclosure provides a three-dimensional printing apparatus capable of improving the condition of a manufacturing process interruption.

A three-dimensional printing apparatus of the disclosure includes a platform, a printing head, a filament box, a connecting member, and a first guiding tube. The printing head is disposed above the platform. The filament box is configured to provide a first filament and a second filament. The connecting member is disposed between the printing head and the filament box. The connecting member includes a main body, a first transfer tube, a second transfer tube and a third transfer tube. The main body has a first passage, a second passage and a third passage communicating with each other, wherein the first passage, the second passage and the third passage respectively communicate with an outside. The first transfer tube is detachably mounted to the main body, wherein the first transfer tube communicates with the first passage, and the first filament enters the first passage through the first transfer tube. The second transfer tube is detachably mounted to the main body, wherein the second transfer tube communicates with the second passage, and the second filament enters the second passage through the second transfer tube. The third transfer tube is detachably mounted to the main body, wherein the third transfer tube communicates with the third passage, and the first filament or the second filament enters the third transfer tube through the third passage. The first guiding tube is connected to the third transfer tube and the printing head, wherein the first guiding tube communicates with the third transfer tube, and the first filament or the second filament enters the printing head through the first guiding tube.

In an embodiment of the disclosure, the three-dimensional printing apparatus further includes a control component, a first driving component and a second driving component. The first driving component is electrically coupled to the control component and is disposed at the filament box to drive the first filament to move. The second driving component is electrically coupled to the control component and is disposed at the filament box to drive the second filament to move.

In an embodiment of the disclosure, the three-dimensional printing apparatus further includes a first sensor electrically coupled to the control component and disposed at the printing head corresponding to the first guiding tube to sense whether the first filament or the second filament enters the printing head or withdraws from the printing head.

In an embodiment of the disclosure, the three-dimensional printing apparatus further includes a second sensor and a third sensor. The second sensor is electrically coupled to the control component and is disposed at the filament box corresponding to the first filament to sense whether the first filament moves out from the filament box or is recycled into the filament box. The third sensor is electrically coupled to the control component and is disposed at the filament box corresponding to the second filament to sense whether the second filament moves out from the filament box or is recycled into the filament box.

In an embodiment of the disclosure, an included angle between the third passage and the first passage is ranged between 17.5 degrees and 22.5 degrees.

In an embodiment of the disclosure, an included angle between the third passage and the second passage is ranged between 17.5 degrees and 22.5 degrees.

In an embodiment of the disclosure, the three-dimensional printing apparatus further includes a second guiding tube and a third guiding tube. The second guiding tube is connected to the first transfer tube and the filament box to allow the first filament to pass through. The third guiding tube is connected to the second transfer tube and the filament box to allow the second filament to pass though.

In an embodiment of the disclosure, an external surface of the main body is provided with a plurality of first positioning parts respectively connected to the first passage, the second passage and the third passage. The first transfer tube, the second transfer tube and the third transfer tube each include a second positioning part, wherein the second positioning part of the first transfer tube is joined with the first positioning part connected to the first passage, the second positioning part of the second transfer tube is joined with the first positioning part connected to the second passage, and the second positioning part of the third transfer tube is joined with the first positioning part connected to the third passage.

In an embodiment of the disclosure, each of the first positioning parts is provided with a first screw thread, and each of the second positioning parts is provided with a second screw thread matching the first screw thread of the corresponding first positioning part.

In an embodiment of the disclosure, a material of the main body includes polyoxymethylene.

Based on the above, the three-dimensional printing apparatus of the disclosure is provided with the connecting member, and at least two filaments pass through the connecting member. With the design of the internal passages of the connecting member, the three-dimensional printing apparatus of the disclosure can select one filament to enter the printing head to perform the printing operation. More specifically, when the originally used filament is about to be exhausted, another filament can be instantly delivered from the connecting member to the printing head to continue the printing operation to prevent occurrence of a printing interruption. Alternatively, according to the settings of the materials and colors of the filaments, the corresponding filament is instantly alternated and delivered to the printing head to prevent occurrence of a printing interruption. On the other hand, since the transfer tubes are detachably mounted on the connecting member, if the internal passage of the connecting member is blocked, the operator can quickly detach the transfer tubes to determine on the blockage and eliminate it.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a three-dimensional printing apparatus of an embodiment of the disclosure.

FIG. 2 is an enlarged schematic view of a printing head, a connecting member and a filament box of FIG. 1.

FIG. 3 is a schematic cross-sectional view of the connecting member of FIG. 2.

FIG. 4 is a schematic cross-sectional view at the time of alternation of the filament in the connecting member of FIG. 3.

### DESCRIPTION OF THE EMBODIMENTS

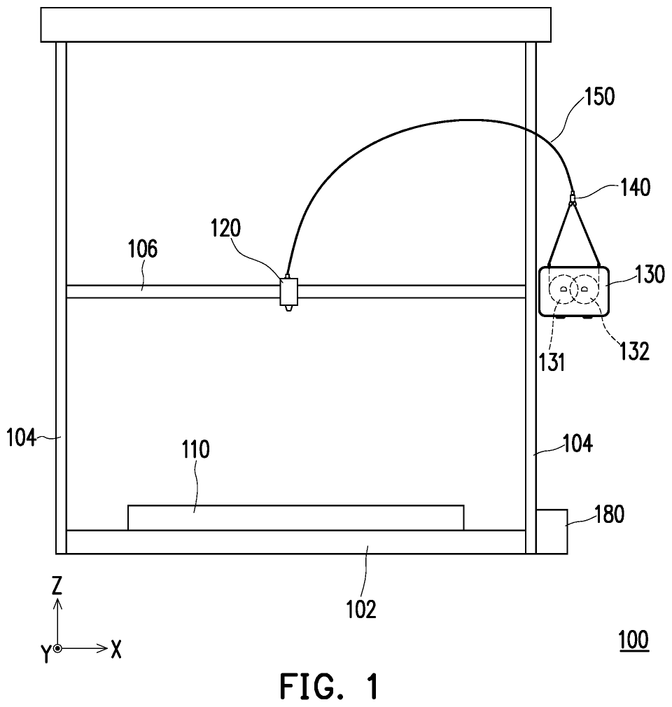

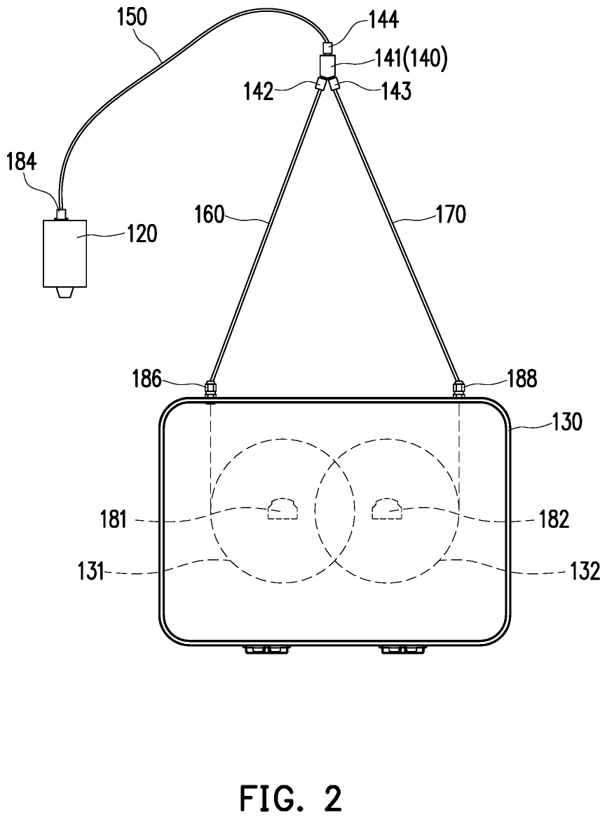

FIG. 1 is a schematic view of a three-dimensional printing apparatus of an embodiment of the disclosure. FIG. 2 is an enlarged schematic view of a printing head, a connecting member and a filament box of FIG. 1. Referring to FIG. 1 and FIG. 2, in the present embodiment, a three-dimensional printing apparatus 100 adopts a fused deposition modeling technique to materialize a digital three-dimensional model, i.e., printing a three-dimensional object (not shown) according to digital three-dimensional model information. Specifically, the three-dimensional printing apparatus 100 includes a platform 110, a printing head 120, a filament box 130, a connecting member 140 and a first guiding tube 150. The platform 110 is disposed on a base 102 and is used to receive the melted filament output from the printing head 120. Moreover, the platform 110 is, for example, stationary or has a degree of freedom of movement in at least one direction (e.g., direction Y) in space.

In the present embodiment, the printing head 120 and the filament box 130 are disposed at one side of the platform 110 through a rack 106 and guiding rails 104. The filament box 130 is used to provide a first filament 131 and a second filament 132 to the printing head 120. For example, the printing head 120 is mounted on the rack 106 and is movable with respect to the platform 110 in the direction X through the rack 106. The number of the guiding rails 104 is two, and the guiding rails 104 are disposed as a pair at two opposite sides of the rack 106 (or disposed at two opposite sides of the platform 110). Two opposite ends of the rack 106 are respectively connected to the two guiding rails 104. The rack 106 is movable with respect to the platform 110 in the direction Z through the two guiding rails 104, and the printing head 120 can move synchronously with the rack 106. On the other hand, the two guiding rails 104 may have a degree of freedom of movement with respect to the platform 110 in the direction Y, and the rack 106 and the printing head 120 can move synchronously with the two guiding rails 104. It is noted that the disclosure does not limit the three-dimensional moving mechanism of the three-dimensional printing apparatus, and another three-dimensional moving mechanism may be adopted according to the actual design requirements, such that the printing head can move with respect to the platform in three directions in space.

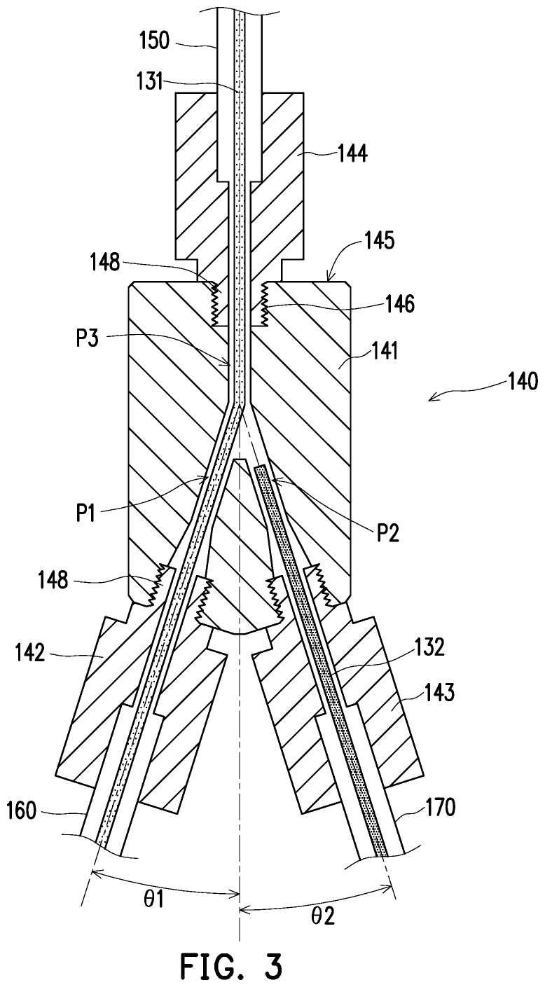

FIG. 3 is a schematic cross-sectional view of the connecting member of FIG. 2. Referring to FIG. 1 to FIG. 3, in the present embodiment, the connecting member 140 is disposed between the printing head 120 and the filament box 130 such that the first filament 131 and the second filament 132 can penetrate therein and one of the first filament 131 and the second filament 132 is selected to be output to the printing head 120. Specifically, the connecting member 140 includes a main body 141, a first transfer tube 142, a second transfer tube 143 and a third transfer tube 144. The first transfer tube 142, the second transfer tube 143 and the third transfer tube 144 are detachably mounted to the periphery of the main body 141 and communicate with the internal passage of the main body 141.

The main body 141 has a first passage P1, a second passage P2 and a third passage P3 that communicate with each other. The first passage P1, the second passage P2 and the third passage P3 respectively communicate with the outside, and the first passage P1, the second passage P2 and the third passage P3 form a Y shape. For example, the material of the main body 141 may include polyoxymethylene (POM) to prevent the first filament 131 and the second filament 132 passing through the main body 141 from melting due to conduction of heat and thereby avoiding a condition in which the first passage P1, the second passage P2, or the third passage P3 is blocked. In other embodiments, the material of the main body may also be polytetrafluoroethylene (PTFE) or another material with low thermal conductivity or a thermal insulation material.

In the present embodiment, the first transfer tube 142 is mounted to the main body 141 in alignment with the first passage P1 and communicates with the first passage P1. The first filament 131 can enter the first passage P1 through the first transfer tube 142. The second transfer tube 143 is mounted to the main body 141 in alignment with the second passage P2 and communicates with the second passage P2. The second filament 132 can enter the second passage P2 through the second transfer tube 143. On the other hand, the third transfer tube 144 is mounted to the main body 141 in alignment with the third passage P3 and communicates with the third passage P3. As shown in FIG. 3, the first filament 131 further penetrates into the third passage P3 and enters the third transfer tube 144. Moreover, the first guiding tube 150 is connected to the third transfer tube 144 and the printing head 120, so the first filament 131 can be further delivered to the printing head 120 through the first guiding tube 150, as shown in FIG. 2 and FIG. 3.

In other embodiments, the first filament may remain in the first passage, and instead, the second filament is penetrated into the third passage and enters the third transfer tube. Subsequently, the second filament is further delivered to the printing head through the first guiding tube. In other words, the disclosure does not limit the order in which the first filament and the second filament are delivered to the printing head. Furthermore, the selection of the first filament and the second filament includes the following combinations: in the same material and the same color; in the same material but different colors; in different materials but the same color; and in different materials and different colors, depending on the requirements of the manufacturing process.

Referring to FIG. 1 and FIG. 2, in the present embodiment, the three-dimensional printing apparatus 100 further includes a control component 180, a first driving component 181 and a second driving component 182. The first driving component 181 and the second driving component 182 are disposed at the filament box 130 and are electrically coupled to the control component 180 in a wired or wireless manner. For example, the first driving component 181 and the second driving component 182 may be motors respectively used to couple to a roller wound with the first filament 131 and a roller wound with the second filament 132. Therefore, the first driving component 181 and the second driving component 182 may operate or stop operating under the control of the control component 180 and are respectively used to output, stop outputting, recycle, or stop recycling the first filament 131 and the second filament 132.

For example, the control component 180 may be a central processing unit (CPU), a system on chip (SOC), or another programmable microprocessor, digital signal processor (DSP), programmable controller, application specific integrated circuit (ASIC), programmable logic device (PLD) for general or specific purposes, another similar processing device, or a combination of these devices. The control component 180 may be used to read and process digital three-dimensional model information for controlling the motion trajectory of the printing head 120 and the distance of the printing head 120 with respect to the platform 110, and the operations of the first driving component 181 and the second driving component 182.

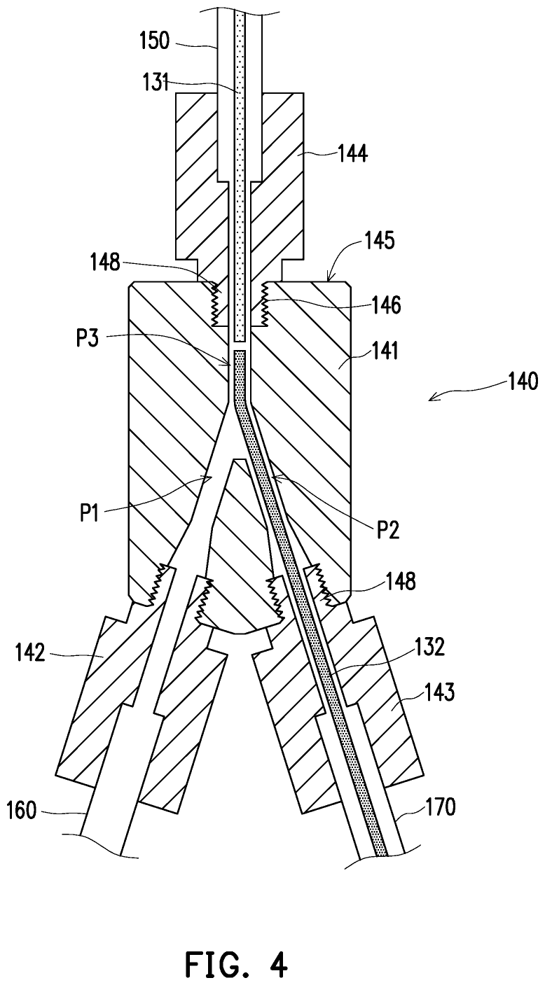

FIG. 4 is a schematic cross-sectional view at the time of alternation of the filament in the connecting member of FIG. 3. Referring to FIG. 1 to FIG. 4, in the present embodiment, the three-dimensional printing apparatus 100 further includes a first sensor 184. The first sensor 184 is electrically coupled to the control component 180 in a wired or wireless manner and is disposed at the printing head 120 corresponding to the first guiding tube 150. Accordingly, the first sensor 184 can be used to sense whether the filament enters the printing head 120 or withdraws from the printing head 120. For example, in the process of printing using the first filament 131, the first filament 131 is continuously delivered to the printing head 120. When the first sensor 184 does not sense that the first filament 131 enters the printing head 120 from the first guiding tube 150, it means that the first filament 131 is about to be exhausted. At this time, the first sensor 184 sends a switching signal to the control component 180. The control component 180 receiving the switching signal turns off the first driving component 181 and turns on the second driving component 182 to drive the second filament 132 to enter the third passage P3 from the second passage P2 and move the second filament 132 sequentially through the third transfer tube 144 and the first guiding tube 150 to enter the printing head 120, such that the second filament 132 can instantly continue the printing operation to avoid a printing interruption.

If the printing operation is performed using the second filament 132 first, when the first sensor 184 does not sense that the second filament 132 enters the printing head 120 from the first guiding tube 150, it means that the second filament 132 is about to be exhausted. At this time, the first sensor 184 sends a switching signal to the control component 180. The control component 180 receiving the switching signal turns off the second driving component 182 and turns on the first driving component 181 to drive the first filament 131 to enter the third passage P3 from the first passage P1 and move and the first filament 131 sequentially through the third transfer tube 144 and the first guiding tube 150 to enter the printing head 120.

On the other hand, the three-dimensional printing apparatus 100 further includes a second sensor 186 and a third sensor 188. The second sensor 186 and the third sensor 188 are electrically coupled to the control component 180 in a wired or wireless manner. More specifically, the second sensor 186 is disposed at the filament box 130 corresponding to the first filament 131 and is used to sense whether the first filament 131 moves out from the filament box 130 or is recycled into the filament box 130. The third sensor 188 is disposed at the filament box 130 corresponding to the second filament 132 and is used to sense whether the second filament 132 moves out from the filament box 130 or is recycled into the filament box 130. For example, in the case where the distance between the output port of the first filament 131 of the filament box 130 and the intersection between the first passage P1 and the third passage P3 of the main body 141 is known, when the rear end of the first filament 131 passes by the second sensor 186 and is sensed by the second sensor 186, the second sensor 186 sends a switching signal to the control component 180, and the rear end of the first filament 131 will move into the third passage P3 within a specific time. Accordingly, the control component 180 receiving the switching signal turns on the second driving component 182 after the specific time to drive the second filament 132 to enter the third passage P3 from the second passage P2 and move the second filament 132 sequentially through the third transfer tube 144 and the first guiding tube 150 to enter the printing head 120, such that the second filament 132 can instantly continue the printing operation to avoid a printing interruption.

If the printing operation is performed using the second filament 132 first, in the case where the distance between the output port of the second filament 132 of the filament box 130 and the intersection between the second passage P2 and the third passage P3 of the main body 141 is known, when the rear end of the second filament 132 passes by the third sensor 188 and is sensed by the third sensor 188, the third sensor 188 sends a switching signal to the control component 180, and the rear end of the second filament 132 will move into the third passage P3 within a specific time. Accordingly, the control component 180 receiving the switching signal turns on the first driving component 181 after the specific time to drive the first filament 131 to enter the third passage P3 from the first passage P1 and move the first filament 131 sequentially through the third transfer tube 144 and the first guiding tube 150 to enter the printing head 120.

In the process of printing using the first filament 131, if the second filament 132 instead is to be used to continue the printing operation, the first driving component 181 is controlled through the control component 180 to recycle the first filament 131 to drive the first filament 131 to sequentially withdraw from the printing head 120, the first guiding tube 150, the third transfer tube 144, and the third passage P3. In the case where the length of the guiding tube (or the distance between the connecting portion between the printing head 120 and the first guiding tube 150 and the intersection between the first passage P1 and the third passage P3 of the main body 141) is known, when the front end of the first filament 131 passes by the first sensor 184 and is sensed by the first sensor 184, the first sensor 184 sends a switching signal to the control component 180, and the front end of the first filament 131 will move back to the first passage P1 within a specific time. Accordingly, the control component 180 receiving the switching signal turns on the second driving component 182 after the specific time to drive the second filament 132 to enter the third passage P3 from the second passage P2 and move the second filament 132 sequentially through the third transfer tube 144 and the first guiding tube 150 to enter the printing head 120, such that the second filament 132 can instantly continue the printing operation to avoid a printing interruption.

In the process of printing using the second filament 132, if the first filament 131 instead is to be used to continue the printing operation, the second driving component 182 is controlled through the control component 180 to recycle the second filament 132 to drive the second filament 132 to sequentially exit from the printing head 120, the first guiding tube 150, the third transfer tube 144, and the third passage P3. In the case where the length of the guiding tube (or the distance between the connecting portion between the printing head 120 and the first guiding tube 150 and the intersection between the second passage P2 and the third passage P3 of the main body 141) is known, when the front end of the second filament 132 passes by the first sensor 184 and is sensed by the first sensor 184, the first sensor 184 sends a switching signal to the control component 180, and the front end of the second filament 132 will move back to the second passage P2 within a specific time. Accordingly, the control component 180 receiving the switching signal turns on the first driving component 181 after the specific time to drive the first filament 131 to enter the third passage P3 from the first passage P1 and move the first filament 131 sequentially through the third transfer tube 144 and the first guiding tube 150 to enter the printing head 120.

Referring to FIG. 3, in the present embodiment, an included angle θ1 between the third passage P3 and the first passage P1 is ranged between 17.5 degrees and 22.5 degrees, and an included angle θ2 between the third passage P3 and the second passage P2 is ranged between 17.5 degrees and 22.5 degrees. In other words, the included angle between the first passage P1 and the second passage P2 is substantially between 35 degrees and 45 degrees. With the included angle setting between any two of the passages, the filament can move through smoothly, and conditions such as unsmooth movement, excessively bending, breakage, etc. do not tend to occur.

On the other hand, the three-dimensional printing apparatus 100 further includes a second guiding tube 160 and a third guiding tube 170 respectively used to guide the first filament 131 and the second filament 132. More specifically, as shown in FIG. 2, the second guiding tube 160 is connected to the first transfer tube 142 and the filament box 130 to allow the first filament 131 to be delivered from the filament box 130 to the first transfer tube 142 through the second guiding tube 160 and further to the printing head 120. The third guiding tube 170 is connected to the second transfer tube 143 and the filament box 130 to allow the second filament 132 to be delivered from the filament box 130 to the second transfer tube 143 through the third guiding tube 170 and further to the printing head 120. In other embodiments, the three-dimensional printing apparatus is optionally not provided with the second guiding tube and the third guiding tube, and the first filament and the second filament may be respectively taken out from the filament box through manual wire leading and respectively penetrate into the first transfer tube and the second transfer tube.

As shown in FIG. 3 and FIG. 4, an external surface 145 of the main body 141 is provided with a plurality of first positioning parts 146 respectively connected to the first passage P1, the second passage P2, and the third passage P3. Moreover, the first transfer tube 142, the second transfer tube 143, and the third transfer tube 144 each include a second positioning part 148. The second positioning part 148 of the first transfer tube 142 is joined with the first positioning part 146 that is connected to the first passage P1, the second positioning part 148 of the second transfer tube 143 is joined with the first positioning part 146 that is connected to the second passage P2, and the second positioning part 148 of the third transfer tube 144 is joined with the first positioning part 146 that is connected to the third passage P3.

Specifically, each of the first positioning parts 146 may be a positioning recess recessed from the external surface 145 of the main body 141, and each of the second positioning parts 148 may be a positioning protrusion that matches the positioning recess. In the present embodiment, each of the positioning recesses may be provided with an inner screw thread, and each of the positioning protrusions may be provided with an outer screw thread, such that each of the transfer tubes can be quickly assemble to the main body 141 or detached from the main body 141 through the coordination of the inner and outer screw threads. Accordingly, if blockage occurs in the internal passage of the connecting member 140, the operator can quickly detach the transfer tubes to determine on the blockage and eliminate it. In other embodiments, each of the first positioning parts may be a positioning protrusion protruding from the external surface of the main body, and each of the second positioning parts may be a positioning recess that matches the positioning protrusion. In addition, the joining method of the positioning protrusions and the positioning recesses is not limited to fixing by locking and may also be fixing by magnetic attachment, fixing by engagement, etc.

In summary of the above, the three-dimensional printing apparatus of the disclosure is provided with the connecting member, and at least two filaments pass through the connecting member. With the design of the internal passages of the connecting member, the three-dimensional printing apparatus of the disclosure can select one filament to enter the printing head to perform the printing operation. More specifically, when the originally used filament is about to be exhausted, another filament can be instantly delivered from the connecting member to the printing head to continue the printing operation to prevent occurrence of a printing interruption. Alternatively, according to the settings of the materials and colors of the filaments, the corresponding filament is instantly alternated and delivered to the printing head to prevent occurrence of a printing interruption. On the other hand, since the transfer tubes are detachably mounted on the connecting member, if the internal passage of the connecting member is blocked, the operator can quickly detach the transfer tubes to determine on the blockage and eliminate it.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A three-dimensional printing apparatus comprising:
a platform;
a printing head, disposed above the platform;
a filament box, configured to provide a first filament and a second filament;
a connecting member, disposed between the printing head and the filament box, the connecting member comprising:
a main body having a first passage, a second passage and a third passage communicating with each other, wherein the first passage, the second passage and the third passage respectively communicate with an outside;
a first transfer tube, detachably mounted to the main body, wherein the first transfer tube communicates with the first passage, and the first filament enters the first passage through the first transfer tube;
a second transfer tube, detachably mounted to the main body, wherein the second transfer tube communicates with the second passage, and the second filament enters the second passage through the second transfer tube; and
a third transfer tube, detachably mounted to the main body, wherein the third transfer tube communicates with the third passage, and the first filament or the second filament enters the third transfer tube through the third passage; and
a first guiding tube, connected to the third transfer tube and the printing head, wherein the first guiding tube communicates with the third transfer tube, and the first filament or the second filament enters the printing head through the first guiding tube.

2. The three-dimensional printing apparatus according to claim 1, further comprising:
a control component;
a first driving component, electrically coupled to the control component and disposed at the filament box to drive the first filament to move; and
a second driving component, electrically coupled to the control component and disposed at the filament box to drive the second filament to move.

3. The three-dimensional printing apparatus according to claim 2, further comprising:
a first sensor, electrically coupled to the control component and disposed at the printing head corresponding to the first guiding tube to sense whether the first filament or the second filament enters the printing head or withdraws from the printing head.

4. The three-dimensional printing apparatus according to claim 2, further comprising:
a second sensor, electrically coupled to the control component and disposed at the filament box corresponding to the first filament to sense whether the first filament moves out from the filament box or is recycled into the filament box; and
a third sensor, electrically coupled to the control component and disposed at the filament box corresponding to the second filament to sense whether the second filament moves out from the filament box or is recycled into the filament box.

5. The three-dimensional printing apparatus according to claim 1, wherein an included angle between the third passage and the first passage is ranged between 17.5 degrees and 22.5 degrees.

6. The three-dimensional printing apparatus according to claim 1, wherein an included angle between the third passage and the second passage is ranged between 17.5 degrees and 22.5 degrees.

7. The three-dimensional printing apparatus according to claim 1, further comprising:
a second guiding tube, connected to the first transfer tube and the filament box to allow the first filament to pass through; and
a third guiding tube, connected to the second transfer tube and the filament box to allow the second filament to pass though.

8. The three-dimensional printing apparatus according to claim 1, wherein an external surface of the main body is provided with a plurality of first positioning parts respectively connected to the first passage, the second passage and the third passage, and the first transfer tube, the second transfer tube and the third transfer tube each comprise a second positioning part, wherein the second positioning part of the first transfer tube is joined with the first positioning part connected to the first passage, the second positioning part of the second transfer tube is joined with the first positioning part connected to the second passage, and the second positioning part of the third transfer tube is joined with the first positioning part connected to the third passage.

9. The three-dimensional printing apparatus according to claim 8, wherein each of the first positioning parts is provided with a first screw thread, and each of the second positioning parts is provided with a second screw thread matching the first screw thread of the corresponding first positioning part.

10. The three-dimensional printing apparatus according to claim 1, wherein a material of the main body comprises polyoxymethylene.
